(19) United States
(12) Patent Application Publication
(10) Pub. No.: US 2018/0246617 A1
(43) Pub. Date: Aug. 30, 2018

(54) TRANSPARENT INTERACTIVE TOUCH SYSTEM AND METHOD

(71) Applicant: SMART TECHNOLOGIES ULC, Calgary (CA)

(72) Inventors: Gerald Morrison, Calgary (CA); Edward Tse, Calgary (CA); Sergiy Dets, Calgary (CA); Greg Hartman, Calgary (CA); Joe Wright, Calgary (CA); Michael Boyle, Calgary (CA)

(73) Assignee: SMART TECHNOLOGIES ULC, Calgary (CA)

(21) Appl. No.: 15/756,648

(22) PCT Filed: Aug. 31, 2016
(86) PCT No.: PCT/CA2016/051029

§ 371 Date: Mar. 1, 2018

Related U.S. Application Data
(60) Provisional application No. 62/213,727, filed on Sep. 3, 2015.

(51) Int. Cl. G06F 3/042; G06F 3/041; G06F 3/0488; G06F 3/044

(52) U.S. Cl. CPC G06F 3/0421; G06F 3/0412; G06F 3/04883; G06F 2203/04804; G06F 3/044; G06F 2203/04109; G06F 3/0416

(57) ABSTRACT

The present invention relates to an interactive touch system on a transparent medium and more particularly, the present invention relates to a method and system for improving the contrast of writing on an interactive touch system on a transparent medium. The interactive device has an interactive surface having an interior side and an exterior side. The interior side is observed by at least one emitter and at least one detector. The interactive surface has a privacy layer; the privacy layer transforming between a transparent and a non-transparent state. A processing structure executing instructions detects a pointer contacting the interior side of the interactive surface; and applies a signal to the privacy layer to transform the privacy layer into the non-transparent state.

### CROSS-REFERENCE TO RELATED APPLICATIONS

This application claims the benefit of U.S. Provisional Application No. 62/213,727 to Morrison et al. filed on Sep. 3, 2015, the entire content of which is expressly incorporated herein by reference.

### FIELD OF THE INVENTION

The present invention relates generally to an interactive touch system on a transparent medium. More particularly, the present invention relates to a method and system for improving the contrast of writing on an interactive touch system on a transparent medium.

### BACKGROUND OF THE INVENTION

Glass is increasingly becoming a dominant material in modern building exteriors as customers enjoy how the glass reduces barriers between the inside and outside. Glass exteriors are also about 30% cheaper than many conventional exterior solutions in use at present. The glass surfaces in buildings have also been used for writing such as by using Crayola® Window Crayons specifically for this purpose. Glass surfaces are also highlighted as the tool for brainstorming and whiteboarding in many movies and television shows. Nevertheless, the information on these glass surfaces is typically not retained or requires a note taker to replicate the information onto a more conventional medium such as paper or transcribing the information into a computer.

A similar situation exists with respect to other architectural real estate such as walls of a corridor or other vacant walls in a building. Certain areas of a building may be configured to permit “graffiti” to be written thereto such as providing a dry erase film rolled onto the surface of the wall. Users may then write on the wall or erase items from the wall. The information written typically is not retained or also requires a note take to replicate the information. Alternatively, a user may take photographs of the writing on wall.

Glass surfaces are not well-suited for note taking because the clear surface makes it difficult to read the writing when the background has many contrasting edges, for example, a parking lot with black and white cars makes the ink hard to read. Windows are also not an effective light source in the evening so they can only be used when the sun is out.

U.S. Pat. No. 6,864,882 to SMART Technologies ULC, herein incorporated by reference in its entirety, describes a protected touch panel display screen. A protective barrier is provided through which light and energy can be emitted. The protective barrier has an interior side and an exterior side of a window. A display screen for displaying information is positioned relative to the interior side of the protective barrier. Also positioned relative to the interior side of the protective barrier is a plurality of emitters adapted for emitting energy beams and at least one detector adapted to detect the energy beams emitted by at least one of the emitters. At least one emission guide is positioned relative to the exterior side of the protective barrier. The emission guide is adapted to receive the energy beams emitted by at least one of the plurality of emitters and to channel the received energy beams across the exterior side of the protective barrier and through to the interior side of the protective barrier for detection by the at least one detector. The protective barrier may be implemented such that the display screen, the emitters and the at least one detector are not accessible from the exterior side of the protective barrier.

U.S. Patent Publication No. 2011/0032215 A1 to SMART Technologies ULC, herein incorporated by reference in its entirety, describes a dual sided interactive input system whereby users on both sides of the interactive input system may interact with a projected image on a light transmissive material such as glass, acrylic, Lexan, etc. The display panel has a multilayered arrangement, and comprises a generally rectangular internal support having a light diffusion layer overlying its rear facing major surface. In this embodiment, the internal support is a rigid sheet of acrylic or other suitable energy transmissive material, and the light diffusion layer is a layer of V-CARE™ V-LITE™ fabric that diffuses visible light for displaying the display output of the image generating unit. Overlying both the front facing major surface of the internal support and the diffusion layer are clear protective layers.

The invention described herein at least provides: a transparent surface capable of recording the information written thereto; and a modifiable background that is capable of improving viewing of the information under various different conditions.

### SUMMARY OF THE INVENTION

According to at least one aspect of the invention, there is provided an interactive device comprising: a processing structure; a light transmissive medium, forming part of a wall, the medium having an interior side and an exterior side; the interior side comprising an interactive surface; a tangible computer-readable memory in communication with the processing structure, the memory comprising instructions to configure the processing structure to: detect a pointer contacting the interior side of the medium; and compute the location of said pointer relative to the surface to determine annotations drawn on said surface using the pointer. In some aspects of the invention, the light transmissive surface may be a window, which may be surrounded by a frame on the interior side with the emitter and detector coupled to the frame. The interactive surface may be observed by at least one emitter and at least one detector, or alternatively, the interactive surface may comprise capacitive sensors coated on a substrate.

According to another aspect of the invention, the interactive device may further comprise a layer on the interior or exterior side, the layer transforming between a transparent and a non-transparent state in response the processing structure executing instructions. According to another aspect of the invention, the computer-readable medium may further comprise instructions to configure the processing structure to generate a privacy timer whereby the privacy timer determines when the signal to the privacy layer is disabled.

According to yet another aspect of the invention, the interactive surface may further comprise a diffusive or an illumination layer on the interior or exterior surface; an illuminator configured to emit light into the illumination layer; and a light sensor measuring ambient light on the exterior side. In some example embodiments, the illuminator emits ultraviolet light and the pointer deposits fluorescent ink on the interior side. The computer-readable medium may further comprise instructions to configure the processing structure to receive a measurement of the ambient light on the exterior side; and activating the illuminator if the light levels are below a threshold. Additionally, the ambient light on the interior side may be monitored using a light sensor in order to provide consistent illumination on the interior side of the window. According to yet another aspect of the invention, the computer-readable medium further comprises instructions to configure the processing structure to generate an illuminator timer whereby the illuminator timer determines when the illuminator is deactivated. In other embodiments, the illuminator may be activated if the measurement of ambient light levels is below a threshold. The illuminator may activate the illuminator in proportion to the measurement of the ambient light.

According to other aspects of the invention, there may be a privacy layer on the exterior side wherein the privacy layer may transition between a clear and an opaque state. The privacy layer may be an electro-chromic film that becomes tinted in response to an electrical potential applied thereto.

According to another aspect of the invention, there is provided an touch system kit comprising: a plurality of emitters affixed to an interior frame of a window and emitting light to illuminate at least a portion of the window; a plurality of optical sensors affixed to the interior frame of the window receiving said light; a transceiver; a processing structure in communication with the emitters and the optical sensors; the processing structure further in communication with the transceiver; a computer-readable medium in communication with the processing structure comprising instructions to: emit light from the emitters according to a pattern; receive signals from the optical sensors; interpreting the signals in order to detect a pointer contacting the window; and transmitting the pointer contacts over the transceiver to a remote processing structure. Another aspect of the invention may have the remote processing structure comprising a mobile phone. The touch system kit may also further comprise a film for application to the window; the film comprising at least one of an illumination layer and a diffusive layer; an illuminator configured to emit light into the illumination layer; and at least one light sensor for detecting ambient light levels. The kit may also further comprise instructions to configure the processing structure to: apply a signal to the diffusive layer to transform the diffusive layer into the non-transparent state; and/or determine ambient light levels and if the ambient light levels are below a threshold, activate the illuminator.

According to yet another aspect of the invention, there is provided a method of applying an interactive device to a window comprising: applying a frame to an interior surface of the window; the frame having a plurality of emitters and receivers formed therein; emitting light from the emitters according to a pattern; receiving signals from the receivers at a processing structure; processing the signals to detect and locate a pointer contacting the window; and transmitting the pointer location to a remote processing structure over a transceiver. The method may further comprise applying a film within the frame on the interior surface of the window whereby the film transforms to become non-transparent on detection of the pointer. The method may further comprise pairing the transceiver with a remote transceiver using a unique identifier on the window.

According to another aspect of the invention, there is provided a method of applying an interactive device to a wall comprising: applying a frame to an interior surface of the wall; the frame having a plurality of emitters and receivers formed therein; emitting light from the emitters according to a pattern; receiving signals from the receivers at a processing structure; processing the signals to detect and locate a pointer contacting the wall; transmitting the pointer location to a remote processing structure over a transceiver; and signally the film to transform from a transparent state to a non-transparent state.

According to at least one aspect of the invention, there is provided an interactive device comprising: a processing structure; an interactive surface having an interior side and an exterior side; the interior side observed by at least one emitter and at least one detector; the interactive surface comprising a privacy layer; the privacy layer transforming between a clear and an opaque state; a computer-readable medium comprising instructions to configure the processing structure to: detect a pointer contacting the interior side of the interactive surface; and applying a signal to the privacy layer to transform the privacy layer into the opaque state. The computer-readable medium may further comprise instructions to configure the processing structure to generate a privacy timer whereby the privacy timer determines when the signal to the privacy layer is disabled.

According to another aspect of the invention, the interactive surface further comprises an illumination layer; an illuminator configured to emit light into the illumination layer; and a light sensor measuring ambient light on the exterior side. The computer-readable medium further comprises instructions to configure the processing structure to receive a measurement of the ambient light on the exterior side; and activating the illuminator if the light levels are below a threshold; and generating an illuminator timer whereby the illuminator timer determines when the illuminator is deactivated.

According to any aspect of the invention, the light transmissive medium or surface may further comprise a display.

### BRIEF DESCRIPTION OF THE DRAWINGS

An embodiment will now be described, by way of example only, with reference to the attached Figures, wherein:

FIG. 1 shows an overview of collaborative devices in communication with one or more portable devices and servers;

FIGS. 2A and 2B show a perspective view of a capture board and control icons respectively;

FIGS. 2C to 2E show front views of a transparent capture board in front of a background at various levels of transparency;

FIGS. 2F to 2H show front view of a transparent capture board in front of a background at night at various levels of illumination;

FIGS. 3A to 3C demonstrate a processing architecture of the capture board;

FIGS. 4A to 4E show touch detection systems that may be used with the capture board;

FIGS. 4F to 4J show layers for various configurations of the transparent capture board;

FIG. 5 demonstrates a processing structure of a mobile device;

FIG. 6 shows a processing structure of one of more servers;

FIGS. 7A and 7B demonstrate an overview of processing structure and protocol stack of a communication system;

FIG. 8 shows a flowchart of a control method for a transparent and illuminated capture board;

FIG. 9 shows an example gesture to control light properties of the transparent capture board; and

FIG. 10 shows a room control system incorporating a plurality of transparent capture boards.

### DETAILED DESCRIPTION OF THE EMBODIMENT

While the Background of Invention described above has identified particular problems known in the art, the present invention provides, in part, a new and useful application of adjusting light and/or visual properties of a window.

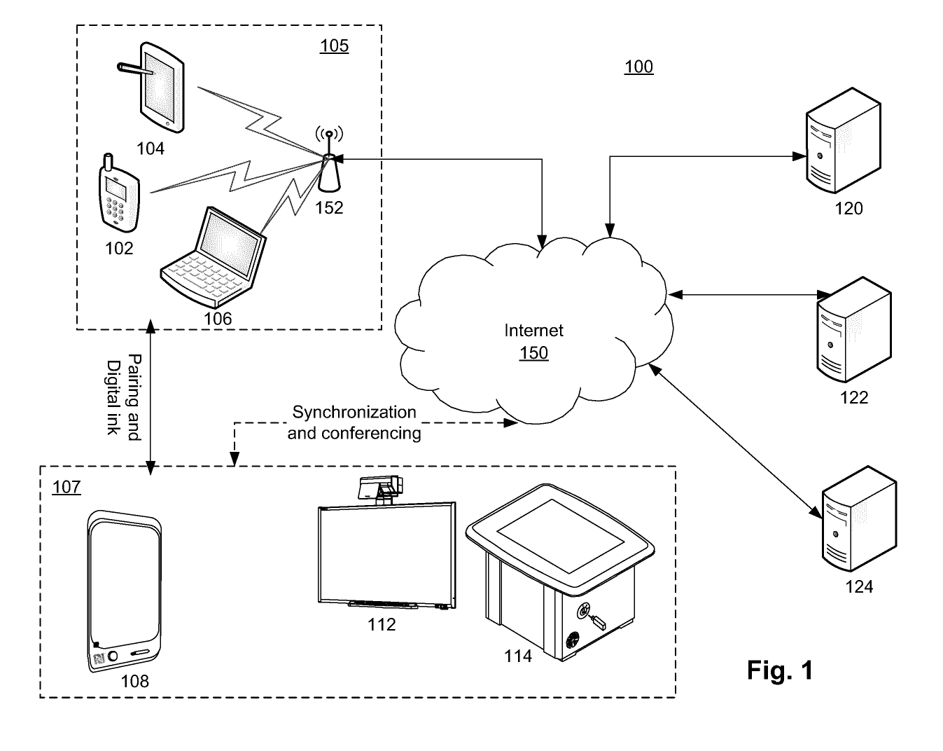

FIG. 1 demonstrates a high-level hardware architecture 100 of the present embodiment. A user has a mobile device 105 such as a smartphone 102, a tablet computer 104, or laptop 106 that is in communication with a wireless access point 152 such as 3G, LTE, WiFi, Bluetooth®, near-field communication (NFC) or other proprietary or non-proprietary wireless communication channels known in the art. The wireless access point 152 allows the mobile devices 105 to communicate with other computing devices over the Internet 150. In addition to the mobile devices 105, a plurality of collaborative devices 107 such as a Kapp™ capture board 108 produced by SMART Technologies, wherein the User's Guide is herein incorporated by reference, an interactive whiteboard 112, or an interactive table 114 may also connected to the Internet 150. The system comprises an authentication server 120, a profile or session server 122, and a content server 124. The authentication server 120 verifies a user login and password or other type of login such as using encryption keys, one time passwords, etc. The profile server 122 saves information (e.g. computer-readable data) about the user logged into the system. The content server 124 comprises three levels: a persistent back-end database, middleware for logic and synchronization, and a web application server. The mobile devices 105 may be paired with the capture board 108 as will be described in more detail below. The capture board 108 may also provide synchronization and conferencing capabilities over the Internet 150 as will also be further described below.

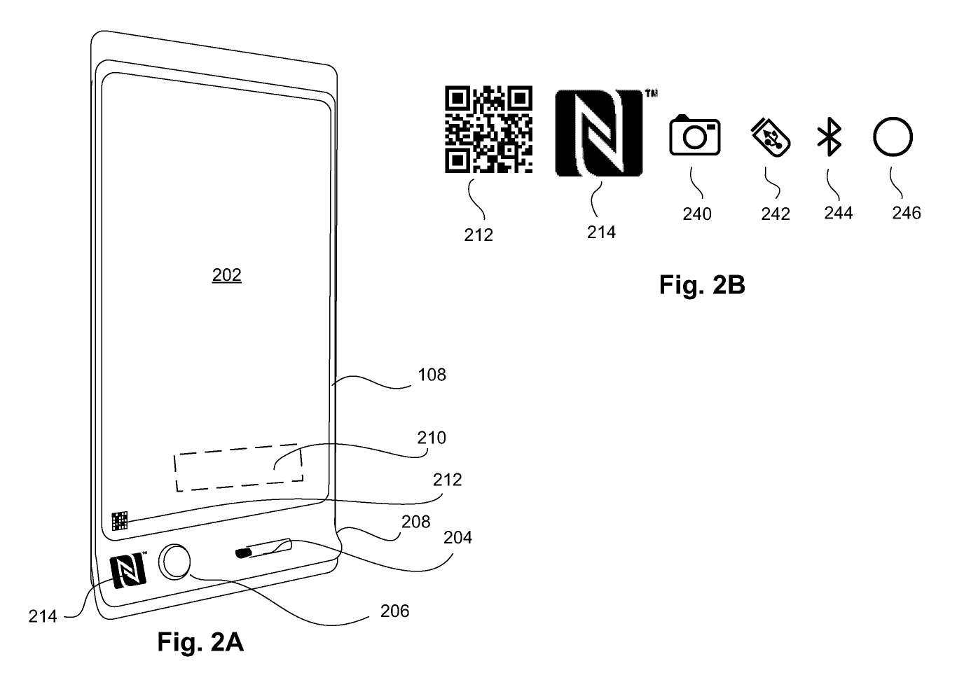

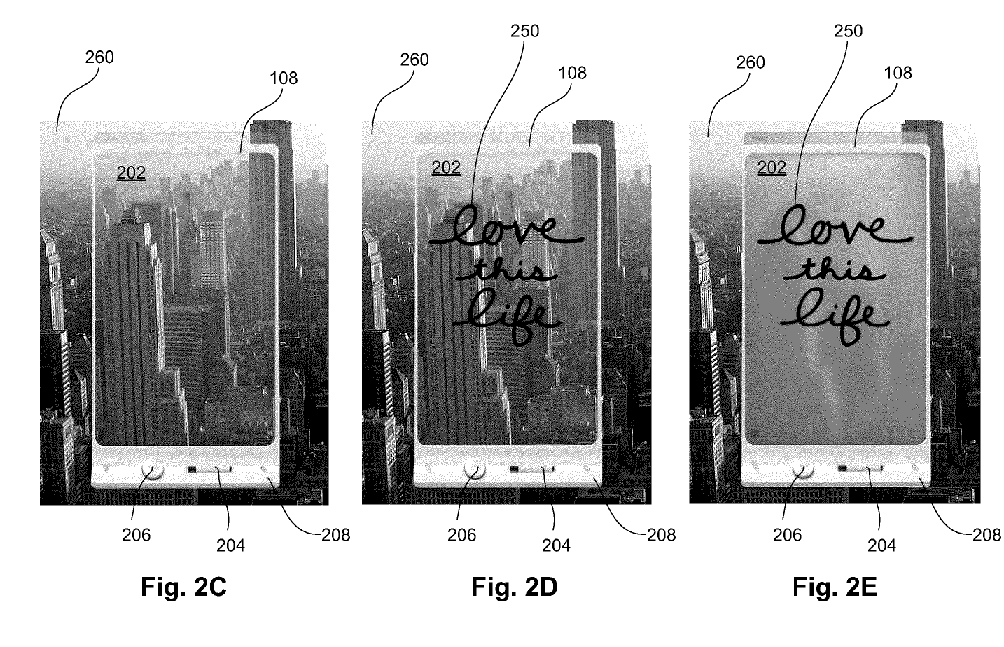

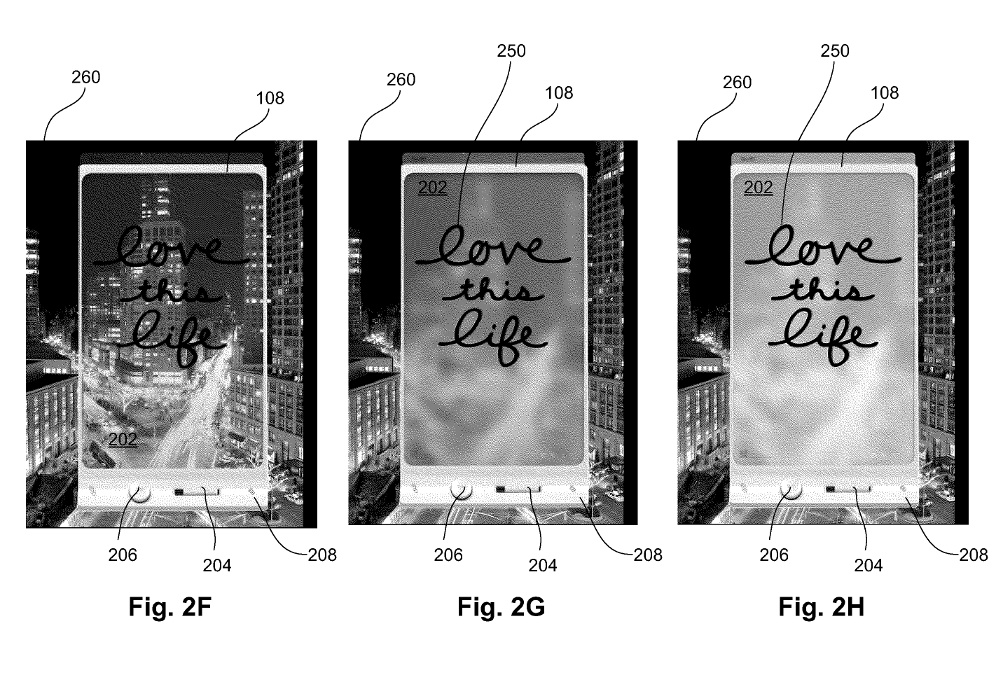

As shown in FIG. 2A, the capture board 108 comprises a generally rectangular transparent touch area 202 whereupon a user may draw using a dry erase marker or pointer 204 and erase using an eraser 206. The capture board 108 may be in a portrait or landscape configuration and may be a variety of aspect ratios. The capture board 108 may be mounted to a vertical support surface such as for example, a wall surface, window or the like. The touch area 202 comprises a touch sensing technology capable of determining and recording the pointer 204 (or eraser 206) position within the touch area 202. The recording of the path of the pointer 204 (or eraser) permits the capture board 108 to have a digital representation of all annotations stored in memory as described in more detail below.

The capture board 108 may comprise at least one of a quick response (QR) code 212 and/or a near-field communication (NFC) area 214 of which may be used to pair the mobile device 105 to the capture board 108. The QR code 212 is a two-dimensional bar code that may be uniquely associated with the capture board 108. In this embodiment, the QR Code 212 comprises a pairing Universal Resource Locator (URL) derived from the Bluetooth address of the board as further described in U.S. Ser. No. 14/712,452, herein incorporated by reference in its entirety.

The NFC area 214 comprises a loop antenna (not shown) that interfaces by electromagnetic induction to a second loop antenna 340 located within the mobile device 105. Near-field communication operates within the globally available and unlicensed radio frequency ISM band of 13.56 MHz on ISO/IEC 18000-3 air interface and at rates ranging from 106 Kbit/s to 424 Kbit/s. In the present embodiment, the NEC area 214 acts as a passive target for the initiator within the mobile device 105. The initiator actively generates an RF field that can power the passive target. This enables NFC targets 214 to be simple form factors such as tags, stickers, key fobs, or battery-less cards, which are inexpensive to produce and easily replaceable. NFC tags 214 contain data (currently between 96 and 4,096 bytes of memory) and are typically read-only, but may be rewritable. In alternative embodiments, NFC peer-to-peer communication is possible, such as placing the mobile device 105 in a cradle. In this alternative, the mobile device 105 is preferably powered. Similar as for the QR code 212, the NEC tag 214 stores the pairing URL produced in a similar manner as for the QR code 212.

As shown in FIG. 2B, an elongate icon control bar 210 may be present adjacent the bottom of the touch area 202 or on the tool tray 208 and this icon control bar may also incorporate the QR code 212 and/or the NFC area 214. All or a portion of the control icons within the icon control bar 210 may be selectively illuminated (in one or more colours) or otherwise highlighted when activated by user interaction or system state. Alternatively, all or a portion of the icons may be completely hidden from view until placed in an active state. The icon control bar 210 may comprise a capture icon 240, a universal serial bus (USB) device connection icon 242, a Bluetooth/WiFi icon 244, and a system status icon 246 as will be further described below.

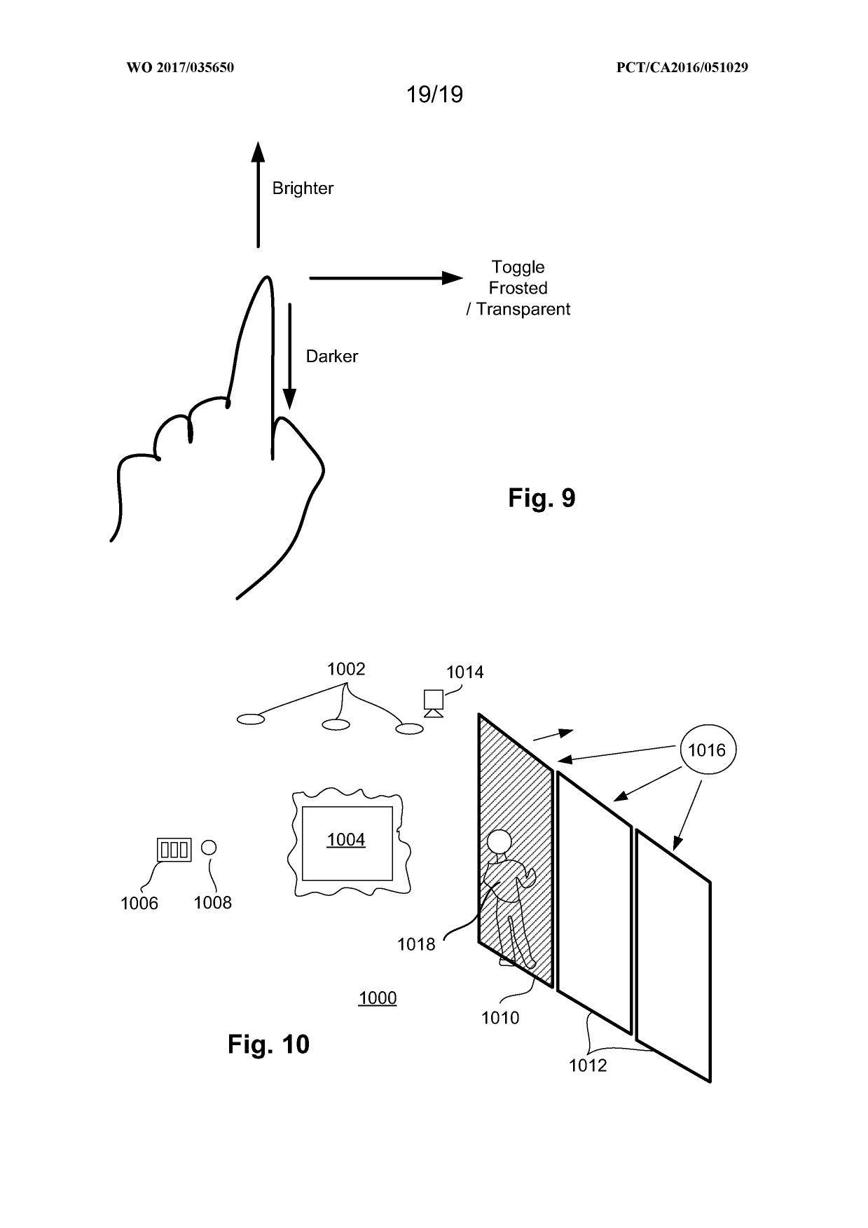

Turning now to FIGS. 2C to 2E, the capture board 108 is presented with a transparent touch area 202 forming part of the interior of a window 260. In FIG. 2C, the touch area 202 is about 78% clear similar to the transparency of the window 260. Other transparency values would apply equally well. Either once a pointer 204 comes into contact with the touch area 202 and/or writing 250 is present on the touch area 202, the transparency decreases and the touch area 202 gradually becomes frosted (which may occur over a user-specified or fixed period of time) as shown in FIG. 2D. When the touch area 202 becomes completely frosted (as shown in FIG. 2E), the background previously visible through the window 260 becomes blurred enabling easier reading of the writing present within the touch area 202. Once frosted, the touch area blocks approximately 93% of the light from outside and reduces the UV rays by approximately 99%. The frosting may revert back to transparency after a user-specified (or fixed) period of time and may be re-frosted upon another pointer 204 contact with the touch area 202. In some embodiments, the transparency and/or colour of the touch area may be gradually change (e.g. analog) or may be toggled (e.g. digital) between dark and light or between transparent and opaque. One or more gestures, such as described with reference to FIG. 9, may initiate changes in the transparency of the touch area 202. For example, a vertical motion on the touch area 202 may brighten or darken the touch area 202 whereas a right motion may toggle the frosted and transparency of the touch area 202. These gestures may be performed on any portion of the touch area 202 or may be performed on a graphic presented on the touch area 202.

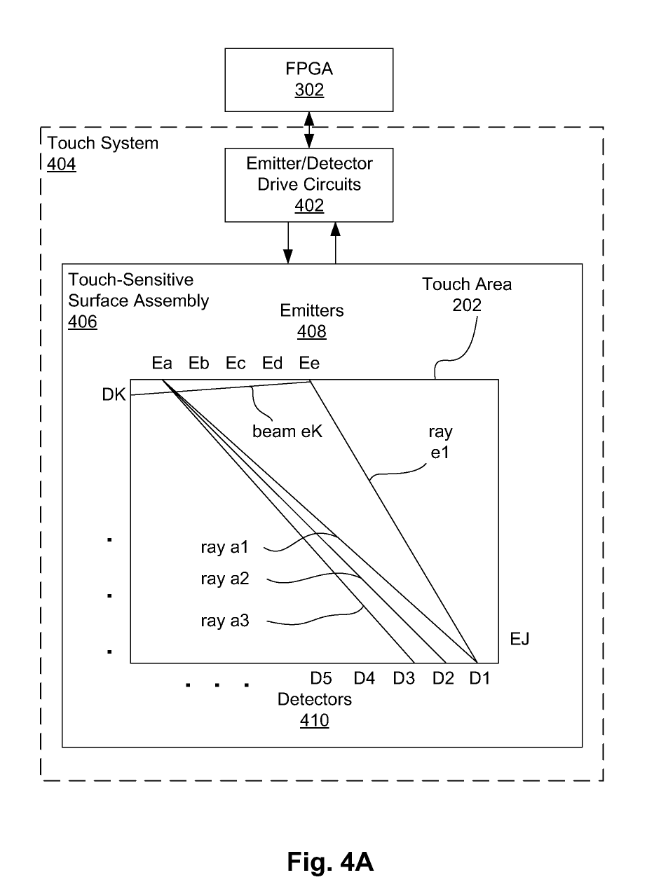

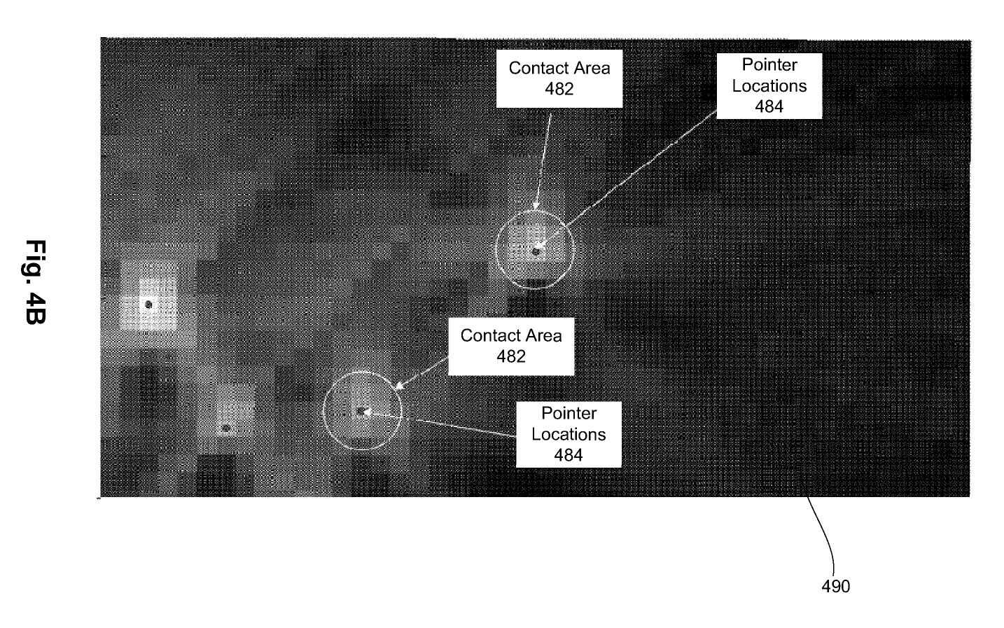

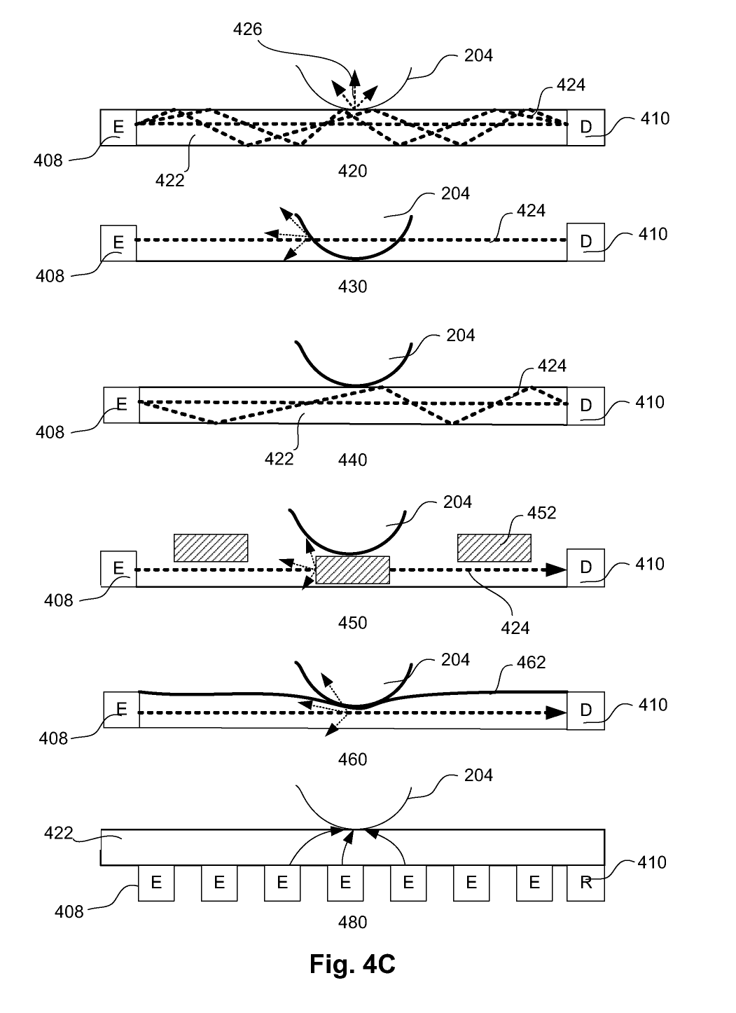

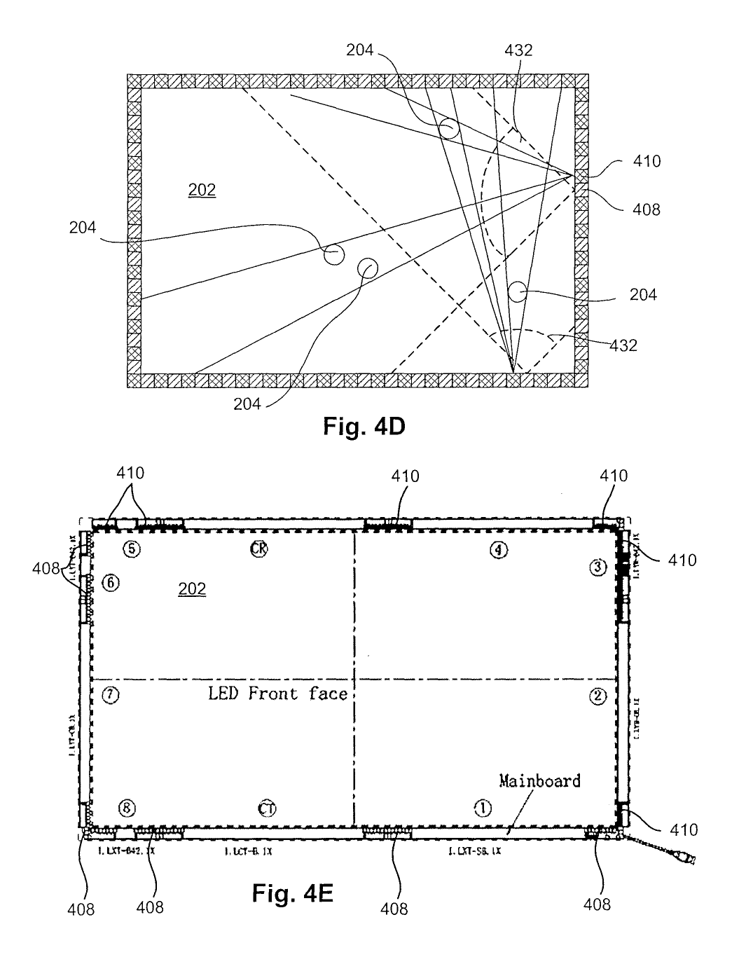

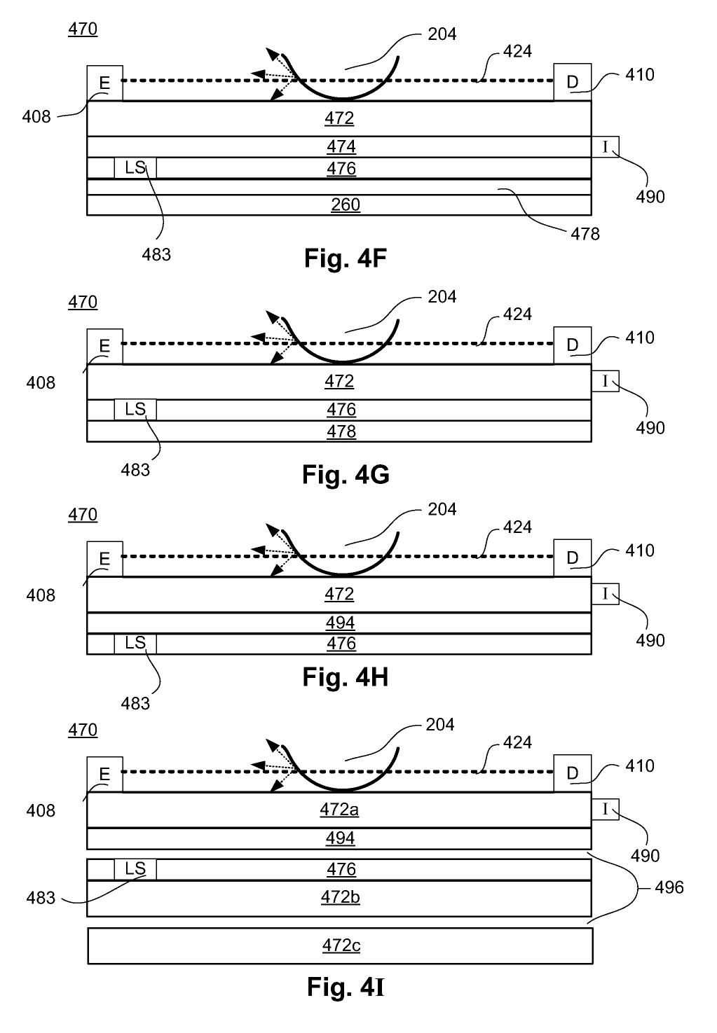

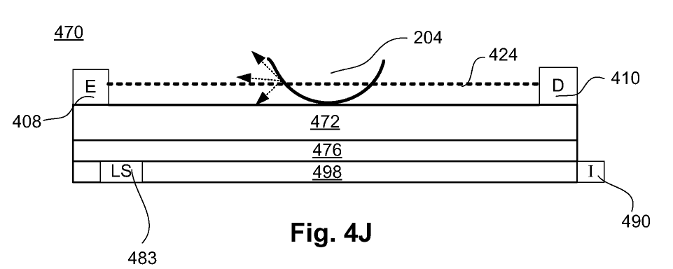

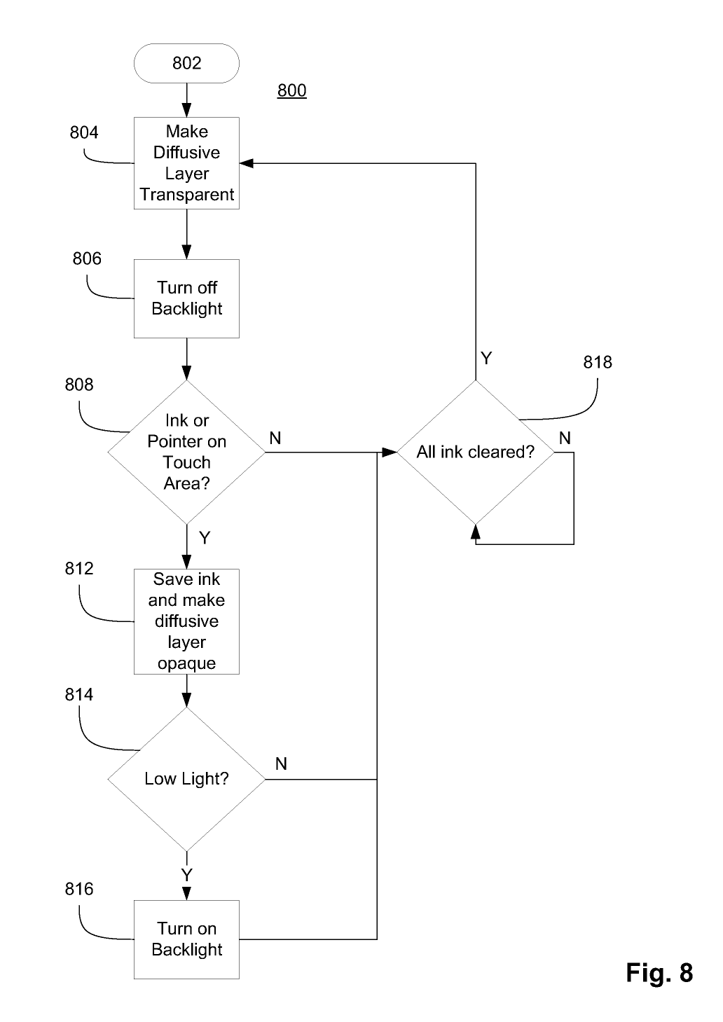

As shown in FIGS. 2F to 2H, a backlight may also inject light into the touch area 202. A light sensor 483, for example shown in FIGS. 4F to 4J detects that there is not sufficient light through the window to see the writing 250 clearly and turns on the backlight 490. When the backlight 490 is off as shown in FIG. 2F, the backlight 490 does not interfere with viewing of the background through the window 260. As the light from the backlight 490 becomes stronger, as shown in FIG. 2G, the background gradually becomes obscured until almost completely obscured as shown in FIG. 2H. The backlight 490 operates in a similar manner as the transparency of FIGS. 2C to 2E described above with regard to gradually brightening the backlight 490 and turning off the backlight 490 after a user-specified period. Further operation of the backlight 490 and transparency is further described with reference to FIG. 4F to 4J and FIG. 8 below. In some embodiments, the backlight 490 may comprise an ultraviolet light of sufficient intensity that it may activate any fluorescent dry erase ink written on the touch area 202.

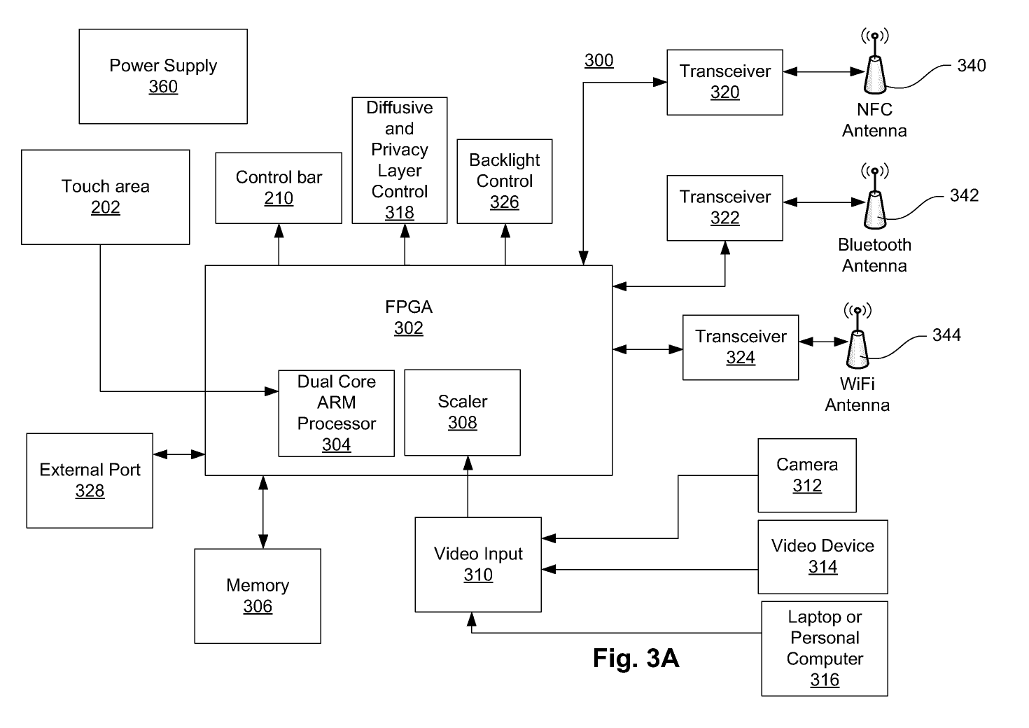

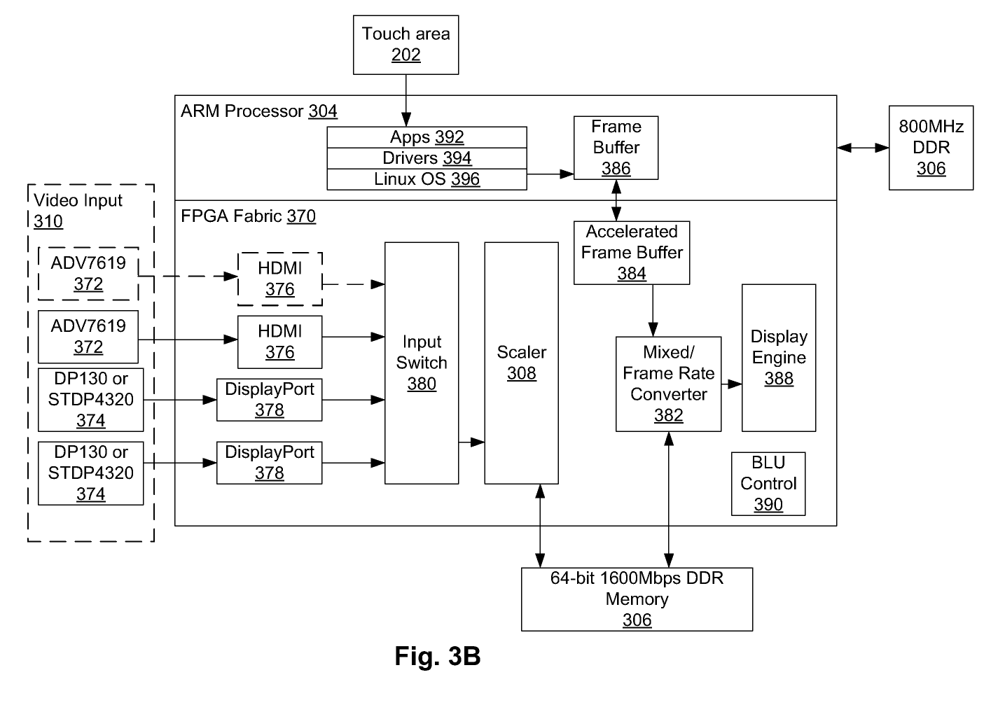

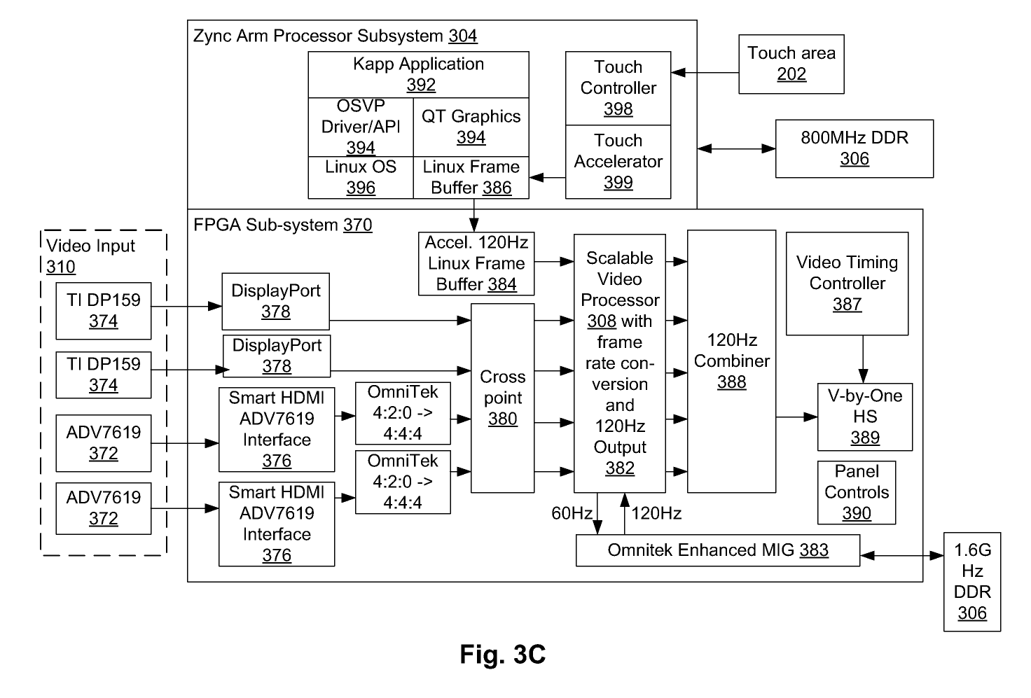

Turning to FIGS. 3A to 3C, the capture board 108 may be controlled with an field programmable gate array (FPGA) 302 or other processing structure which in this embodiment, comprises a dual core ARM Processor 304 executing instructions from volatile or non-volatile memory 306 and storing data thereto. The FPGA 302 may also comprise a scaler 308 which scales video inputs 310. The video input 310 may be from a camera 312, a video device 314 such as a DVD player, Blu Ray™ player, VCR, etc, or a laptop or personal computer 316. The FPGA 302 communicates with the mobile device 105 (or other devices) using one or more transceivers such as, in this embodiment, an NFC transceiver 320 and antenna 340, a Bluetooth transceiver 322 and antenna 342, or a WiFi transceiver 324 and antenna 344. The transceivers and antennas may be incorporated into a single transceiver and antenna. The FPGA 302 may also communicate with an external device 328 such as a USB memory storage device (not shown) where data may be stored thereto. A wired power supply 360 provides power to all the electronic components 300 of the capture board 108. The FPGA 302 interfaces with the previously mentioned icon control bar 210.

When the user contacts the pointer 204 with the touch area 202, the processor 304 tracks the motion of the pointer 204 and stores the pointer contacts in memory 306. Alternatively, the touch points may be stored as motion vectors or Bezier splines. The memory 306 therefore contains a digital representation of the drawn content within the touch area 202. Likewise, when the user contact the eraser 206 with the touch area 202, the processor 304 tracks the motion of the eraser 206 and removes drawn content from the digital representation of the drawn content. In this embodiment, the digital representation of the drawn content is stored in non-volatile memory 306.

When the pointer 204 contacts the touch area 202 in the location of the capture (or snapshot) icon 240, the FPGA 302 detects this contact as a control function which initiates the processor 304 to copy the currently stored digital representation of the drawn content to another location in memory 306 as a new page also known as a snapshot. The capture icon 240 may flash during the saving of the digital representation of drawn content to another memory location. The FPGA 302 then initiates a snapshot message to one or more of the paired mobile device(s) 105 via the appropriately paired transceiver(s) 320, 322, and/or 324. The message contains an indication to the paired mobile device(s) 105 to capture the current image as a new page. The message may also contain any changes that were made to the page after the last update sent to the mobile device(s) 105. The user may then continue to annotate or add content objects within the touch area 202. Once the transfer of the page to the paired mobile device 105 is complete, the page may be deleted from memory 306.

If a USB memory device (not shown) is connected to the external port 328, the FPGA 302 illuminates the USB device connection icon 242 in order to indicate to the user that the USB memory device is available to save the captured pages. When the user contacts the capture icon 240 with the pointer 204 and the USB memory device is present, the captured pages are transferred to the USB memory device as well as being transferred to any paired mobile device 105. The captured pages may be converted into another file format such as PDF, Evernote, XML, Microsoft Word®, Microsoft® Visio, Microsoft® Powerpoint, etc and if the file has previously been saved on the USB memory device, then the pages since the last save may be appended to the previously saved file. During a save to the USB memory, the USB device connection icon 242 may flash to indicate a save is in progress.

If the user contacts the USB device connection icon 242 using the pointer 204 and the USB memory device is present, the FPGA 302 flushes any data caches to the USB memory device and disconnects the USB memory device in the conventional manner. If an error is encountered with the USB memory device, the FPGA 302 may cause the USB device connection icon 242 to flash red. Possible errors may be the USB memory device being formatted in an incompatible format, communication error, or other type of hardware failure.

When one or more mobile devices 105 begins pairing with the capture board 108, the FPGA 302 causes the Bluetooth icon 244 to flash. Following connection, the FPGA 302 causes the Bluetooth icon 244 to remain active. When the pointer 204 contacts the Bluetooth icon 244, the FPGA 302 may disconnect all the paired mobile devices 105 or may disconnect the last connected mobile device 105. When the mobile device 105 is disconnecting from the capture board 108, the Bluetooth icon 244 may flash red in colour. If all mobile devices 105 are disconnected, the Bluetooth icon 244 may be solid red or may not be illuminated.

When the FPGA 302 is powered and the capture board 108 is working properly, the FPGA 302 causes the system status icon 246 to become illuminated. If the FPGA 302 determines that one of the subsystems of the capture board 108 is not operational or is reporting an error, the FPGA 302 causes the system status icon 246 to flash. When the capture board 108 is not receiving power, all of the icons in the control bar 210 are not illuminated.

FIGS. 3B and 3C demonstrate examples of structures and interfaces of the FPGA 302. As previously mentioned, the FPGA 302 has an ARM Processor 304 embedded within it. The FPGA 302 also implements an FPGA Fabric or Sub-System 370 which, in this embodiment comprises mainly video scaling and processing. The video input 310 comprises receiving either High-Definition Multimedia Interface (HDMI) or DisplayPort, developed by the Video Electronics Standards Association (VESA), via one or more Xpressview 3 GHz HDMI receivers (ADV7619) 372 produced by Analog Devices, the Data Sheet and User Guide herein incorporated by reference, or one or more DisplayPort Re-driver (DP130 or DP159) 374 produced by Texas Instruments, the Data Sheet, Application Notes, User Guides, and Selection and Solution Guides herein incorporated by reference. These HDMI receivers 372 and DisplayPort re-drivers 374 interface with the FPGA 302 using corresponding circuitry implementing Smart HDMI Interfaces 376 and DisplayPort Interfaces 378 respectively. An input switch 380 detects and automatically selects the currently active video input. The input switch or crosspoint 380 passes the video signal to the scaler 308 which resizes the video. Once the video is scaled, it is stored in memory 306 where it is retrieved by the mixed/frame rate converter 382.

The ARM Processor 304 has applications or services 392 executing thereon which interface with drivers 394 and the Linux Operating System 396. The Linux Operating System 396, drivers 394, and services 392 may initialize wireless stack libraries. For example, the protocols of the Bluetooth Standard, the Adopted Bluetooth Core Specification v 4.2 Master Table of Contents & Compliance Requirements herein incorporated by reference, may be initiated such as an radio frequency communication (RFCOMM) server, configure Service Discovery Protocol (SDP) records, configure a Generic Attribute Profile (GATT) server, manage network connections, reorder packets, transmit acknowledgements, in addition to the other functions described herein. The applications 392 alter the frame buffer 386 based on annotations entered by the user within the touch area 202.

A mixed/frame rate converter 382 overlays content generated by the Frame Buffer 386 and Accelerated Frame Buffer 384. The Frame Buffer 386 receives annotations and/or content objects from the touch controller 398. The Frame Buffer 386 transfers the annotation (or content object) data to be combined with the existing data in the Accelerated Frame Buffer 384. The converted video is then passed from the frame rate converter 382 to the display engine 388.

In FIG. 3C, a OmniTek Scalable Video Processing Suite, produced by OmniTek of the United Kingdom, the OSVP 2.0 Suite User Guide June 2014 herein incorporated by reference, is implemented. The scaler 308 and frame rate converter 382 are combined into a single processing block where each of the video inputs are processed independently and then combined using a 120 Hz Combiner 388. The scaler 308 may perform at least one of the following on the video: chroma upsampling, colour correction, deinterlacing, noise reduction, cropping, resizing, and/or any combination thereof. An additional feature of the embodiment shown in FIG. 3C is an enhanced Memory Interface Generator (MIG) 383 which optimizes memory bandwidth with the FPGA 302. The touch area 202 provides either transmittance coefficients to a touch controller 398 or may provide raw electrical signals or images. The touch controller 398 then processes the transmittance coefficients to determine touch locations as further described below with reference to FIG. 4A to 4E. The touch accelerator 399 determines which pointer 204 is annotating or adding content objects and injects the annotations or content objects directly into the Linux Frame buffer 386 using the appropriate ink attributes.

The FPGA 302 may also contain backlight control unit (BLU) or panel control circuitry 390 which controls the backlight 490.

The touch area 202 of the embodiment of the invention is observed with reference to FIGS. 4A to 4J and further disclosed in U.S. Pat. No. 8,723,840 to Rapt Touch, Inc. and Rapt IP Ltd., the contents thereof incorporated by reference in their entirety. The FPGA 302 interfaces and controls the touch system 404 comprising emitter/detector drive circuits 402 and a touch-sensitive surface assembly 406. The touch area 202 is the surface on which touch events are to be detected. The surface assembly 406 includes emitters 408 and detectors 410 arranged around the periphery of the touch area 202. The detector 410 in one embodiment operates in a manner similar to a scanning synthetic aperture radar (SAR). In this example, there are K detectors identified as D1 to DK and J emitters identified as Ea to Ej. The emitter/detector drive circuits 402 provide an interface between the FPGA 302 whereby the FPGA 302 is able to independently control and power the emitters 408 and detectors 410. The emitters 408 produce a fan of illumination generally in the infrared (IR) band whereby the light produced by one emitter 408 may be received by more than one detector 410. A “ray of light” refers to the light path from one emitter to one detector irrespective of the fan of illumination being received at other detectors. The ray from emitter Ej to detector Dk is referred to as ray jk. In the present example, rays a1, a2, a3, e1 and eK are examples.

When the pointer 204 contact the touch area 202, the fan of light produced by the emitter(s) 408 is disturbed thus changing the intensity of the ray of light received at each of the detectors 410. The FPGA 302 calculates a transmission coefficient Tjk for each ray in order to determine the location and times of contacts with the touch area 202. The transmission coefficient Tjk is the transmittance of the ray from the emitter j to the detector k in comparison to a baseline transmittance for the ray. The baseline transmittance for the ray is the transmittance measured when there is no pointer 204 interacting with the touch area 202. The baseline transmittance may be based on the average of previously recorded transmittance measurements or may be a threshold of transmittance measurements determined during a calibration phase. Other measures may be used in place of transmittance such as absorption, attenuation, reflection, scattering, or intensity.

The FPGA 302 then processes the transmittance coefficients Tjk from a plurality of rays and determines touch regions corresponding to one or more pointers 204. The FPGA 302 may also calculate one or more physical attributes such as contact pressure, pressure gradients, spatial pressure distributions, pointer type, pointer size, pointer shape, determination of glyph or icon or other identifiable pattern on pointer, etc.

Based on the transmittance coefficients Tjk for each of the rays, a transmittance map is generated by the FPGA 302 such as shown in FIG. 4B. The transmittance map 490 is a grayscale image whereby each pixel in the grayscale image represents a different “binding value” and in this embodiment each pixel has a width and breadth of 2.5 mm. Contact areas 482 are represented as white areas and non-contact areas are represented as dark gray or black areas. The contact areas 482 are determined using various machine vision techniques such as, for example, pattern recognition, filtering, or peak finding. The pointer locations 484 are determined using a method such as peak finding where one or more maximums is detected in the 2D transmittance map within the contact areas 482. Methods for determining these contact locations 484 are disclosed in U.S. Patent Publication No. 2014/0152624, herein incorporated by reference.

Six example configurations for the touch area 202 are presented in FIG. 4C. Configurations 420 to 440 are configurations whereby the pointer 204 interacts directly with the illumination being generated by the emitters 408. Configurations 450 and 460 are configurations whereby the pointer 204 interacts with an intermediate structure in order to influence the emitted light rays. An alternative configuration 480 to the optical configuration previously described is a projected capacitive configuration 480. There are various structures for projected capacitive sensors. One example may be multiple transparent capacitance traces 408 arranged in an X-Y grid, connected with input and output electrodes with a certain pattern, such as a traditional diamond pattern or a “caterpillar” pattern. These capacitance traces and electrodes may be Indium Tin Oxide (ITO) coated on a substrate, such as PET plastic film with a thickness less than 100 μm or a piece of glass.

When a pointer 204 is placed on the glass 422, it disrupts the electric fields generated by the capacitance traces 408. An output signal change of one or more transparent output electrodes 410 connected to the capacitance traces 480 along one direction generally determines the position along the touch area 202 in one direction. Once the position in the first direction has been determined, the capacitance traces 480 orthogonal to the capacitance traces in the first direction will be detected. The signal change from the output electrodes 410 connected to these capacitance traces determines the position of the pointer 204 in this orthogonal direction. This scanning method is only an example, other capacitance sensor configurations and scanning methods such as those disclosed in U.S. Pat. No. 5,790,106 to Alps Electric Co., U.S. Pat. No. 5,677,744, and U.S. Pat. No. 9,182,859, both to Sharp Kabushiki Kaisha, are herein expressly incorporated by reference in their entirety.

A frustrated total internal reflection (FTIR) configuration 420 has the emitters 408 and detectors 410 optically mated to an optically transparent waveguide 422 made of glass or plastic. The light rays 424 enter the waveguide 422 and is confined to the waveguide 422 by total internal reflection (TIR). The pointer 204 having a higher refractive index than air comes into contact with the waveguide 422. The increase in the refractive index at the contact area 482 causes the light to leak 426 from the waveguide 422. The light loss attenuates rays 424 passing through the contact area 482 resulting in less light intensity received at the detectors 410.

A beam blockage configuration 430, further shown in more detail with respect to FIG. 4D, has emitters 408 providing illumination over the touch area 202 to be received at detectors 410 receiving illumination passing over the touch area 202. The emitter(s) 408 has an illumination field 432 of approximately 90-degrees that illuminates a plurality of pointers 204. The pointer 204 enters the area above the touch area 202 whereby it partially or entirely blocks the rays 424 passing through the contact area 482. The detectors 410 similarly have an approximately 90-degree field of view and receive illumination either from the emitters 408 opposite thereto or receive reflected illumination from the pointers 204 in the case of a reflective or retro-reflective pointer 204. The emitters 408 are illuminated one at a time or a few at a time and measurements are taken at each of the receivers to generate a similar transmittance map as shown in FIG. 4B.

Another total internal reflection (TIR) configuration 440 is based on propagation angle. The ray is guided in the waveguide 422 via TIR where the ray hits the waveguide-air interface at a certain angle and is reflected back at the same angle. Pointer 204 contact with the waveguide 422 steepens the propagation angle for rays passing through the contact area 482. The detector 410 receives a response that varies as a function of the angle of propagation.

The configuration 450 show an example of using an intermediate structure 452 to block or attenuate the light passing through the contact area 482. When the pointer 204 contacts the intermediate structure 452, the intermediate structure 452 moves into the touch area 202 causing the structure 452 to partially or entirely block the rays passing through the contact area 482. In another alternative, the pointer 204 may pull the intermediate structure 452 by way of magnetic force towards the pointer 204 causing the light to be blocked.

In an alternative configuration 460, the intermediate structure 452 may be a continuous structure 462 rather than the discrete structure 452 shown for configuration 450. The intermediate structure 452 is a compressible sheet 462 that when contacted by the pointer 204 causes the sheet 462 to deform into the path of the light. Any rays 424 passing through the contact area 482 are attenuated based on the optical attributes of the sheet 462. Other alternative configurations for the touch system are described in U.S. patent Ser. No. 14/452,882 and U.S. patent Ser. No. 14/231,154, both of which are herein incorporated by reference in their entirety.

With reference to FIG. 4E, the emitters 408 and detectors 410 are located in banks around the periphery of the touch area 202. To determine the pointer 204 location, successive pulses of light from the emitters 408 are transmitted to illuminate the touch area 202, and the echo of each pulse is received and recorded by the detectors 410. Signal processing of the recorded echoes allows it then to combine the recordings from the multiple detector 410 locations and allows it to create finer resolution image of the position of the pointer 204.

In examples shown in FIGS. 4F to 4J, during typical use the interior of the window 260 is located at the top of the figure whereas the exterior of the window 260 is located at the bottom of the figure.

An example layer configuration 470 is shown in FIG. 4F comprising three layers. The touch area 202 may be a piece of tempered glass 472 with side looking emitters 408 and detectors 410, or alternatively may comprise a camera-based touch system. This configuration of touch system is only an example and the previously described touch system configurations (420, 430, 440, 450, 460, and 480) as shown in FIG. 4C may also be used. Below the tempered glass 472 comprises an illumination layer 474, which may be a sheet of acrylic with light diffusing particles therein, such as produced by Evonik under the brand name of Endlighten LED. An illuminator 490 such as a plurality of white light emitting diodes (LED) along the exterior of the layer 474 injects light into the illumination layer 474. Alternatively, the LEDs may be embedded directly in the illumination layer 474 and provide light therein. Below the illumination layer 474 may be a diffusive layer 476 comprising a polymer dispersed liquid crystal. In polymer dispersed liquid crystal devices (PDLCs), liquid crystals are dissolved or dispersed into a liquid polymer followed by solidification or curing of the polymer. During the change of the polymer from a liquid to solid, the liquid crystals become incompatible with the solid polymer and form droplets throughout the solid polymer. The curing conditions affect the size of the droplets that in turn affect the final operating properties of the window. Typically, the liquid mix of polymer and liquid crystals is placed between two layers of glass or plastic that include a thin layer of a transparent, conductive material followed by curing of the polymer, thereby forming the basic sandwich structure of the window.

Electrodes from a power supply are attached to the transparent electrodes (not shown). With no applied voltage, the liquid crystals are randomly arranged in the droplets, resulting in scattering of light as it passes through the window assembly. This results in the translucent, “milky white” appearance. When a voltage is applied to the electrodes, the electric field formed between the two transparent electrodes on the glass causes the liquid crystals to align, allowing light to pass through the droplets with very little scattering and resulting in a transparent state. The degree of transparency can be controlled by the applied voltage. This is possible because at lower voltages, only a few of the liquid crystals align completely in the electric field, so only a small portion of the light passes through while most of the light is scattered. As the voltage is increased, fewer liquid crystals remain out of alignment, resulting in less light being scattered. It is also possible to control the amount of light and heat passing through, when tints and special inner layers are used. It is commercially available in rolls as adhesive backed film that can be applied to existing windows or may be built into new windows. As a result, upon a detection of a touch on the touch area 202 of the tempered glass 472, a lower voltage may be activated and applied to PDLC. The transparency of the PDLC the diffusive layer 476 decreases and the touch area 202 gradually becomes frosted as shown in FIG. 2D, enabling easier reading of the ink present within the touch area 202.

Furthermore, when the diffusive layer 476 becomes dark at night or under dark background, the light sensor 483 may detect that there is not sufficient light through the window to see the writing/ink 250 clearly and then turns on the backlight 490. As the light from the backlight 490 becomes stronger, as shown in FIG. 2G, the background from the diffusive layer 476 gradually becomes obscured until almost completely obscured as shown in FIG. 2H.

Turning now to FIG. 4G, there is demonstrated an example configuration 470 comprising two layers. Similar to FIG. 4F, the touch area 202 may be a piece of tempered glass 472 with side looking emitters 408 and detectors 410. An illuminator 490 injects ultraviolet light into the glass 472 that causes fluorescent ink on the glass 472 to fluoresce. Below the glass 472 is a diffusive layer 476 having at least one light sensor 483 embedded therein.

In some embodiments, such as those in FIGS. 4H and 4I, there may be an LED or OLED display layer 494 that is capable of presenting digital information. In particular in FIG. 4H, the display layer 494 may be sandwiched between the glass layer 472 and the diffusive layer 476.

In FIG. 4I, a triple pane window 260 having an interior pane 472a, middle pane 472b, and an exterior pane 472c where each of the panes is separated by an airtight gap 496 that may have a vacuum or an argon gas placed therein to facilitate insulating the interior pane 472a from the exterior pane 472c. The argon gas helps facilitate reducing humidity and increases the privacy by providing additional color to the window 260. A touch area 202 may be applied (in any of the various configurations previously described) to the interior pane 472a to enable determination of pointer location. An illuminator 490 may selectively inject light into the interior pane 472a. The display layer 494 may be placed on the interior pane 472a between the interior pane 472a and the middle pane 472b. The diffusive layer 476 may be placed on the middle pane 472b between the interior pane 472a and the middle pane 472b, which increases the privacy by making the ink hard to read from the exterior side of the window due to the airtight gap 496. In some embodiments, the display layer 494 may be absent. Although a triple pane window 260 is depicted in FIG. 4I, other embodiments have double pane glass.

In yet another example shown in FIG. 4J, a touch system is applied to the interior surface of the tempered glass 472. On the exterior surface of the glass 472 may be the diffusive layer 476, such as a PDLC layer, sandwiched between the glass 472 and a sheet of acrylic 498 with light diffusing particles therein, such as produced by Evonik under the brand name of Endlighten LED.

According to any of the examples described above, below (e.g. closer to the exterior) the diffusive layer 476 further comprise a privacy layer (or film) 478 comprising an electro-chromic film that becomes tinted, such as blue, brown, or yellow, in response to an electric potential being applied thereto, such as those shown in FIGS. 4F and 4G. Alternatively, or in addition to, the privacy layer 478 may be replaced or used in conjunction with thin-metal coatings like micro-blinds that control reflectivity and turning one side of the glass into a mirror.

According to any of the embodiments described above, a projected capacitive layer may be placed between the tempered glass 472 and the diffusive layer 476.

According to any embodiment, with an appropriate anti-glare coating on the top of the tempered glass layer 472, it is possible for the illumination layer 474 to support the touch area 202, the diffusive layer 476, the privacy film 478, or any combination thereof in order to minimize the number of layers 470. Additional layers add cost and complexity to manufacture and therefore, it is desirable to reduce the number of layers.

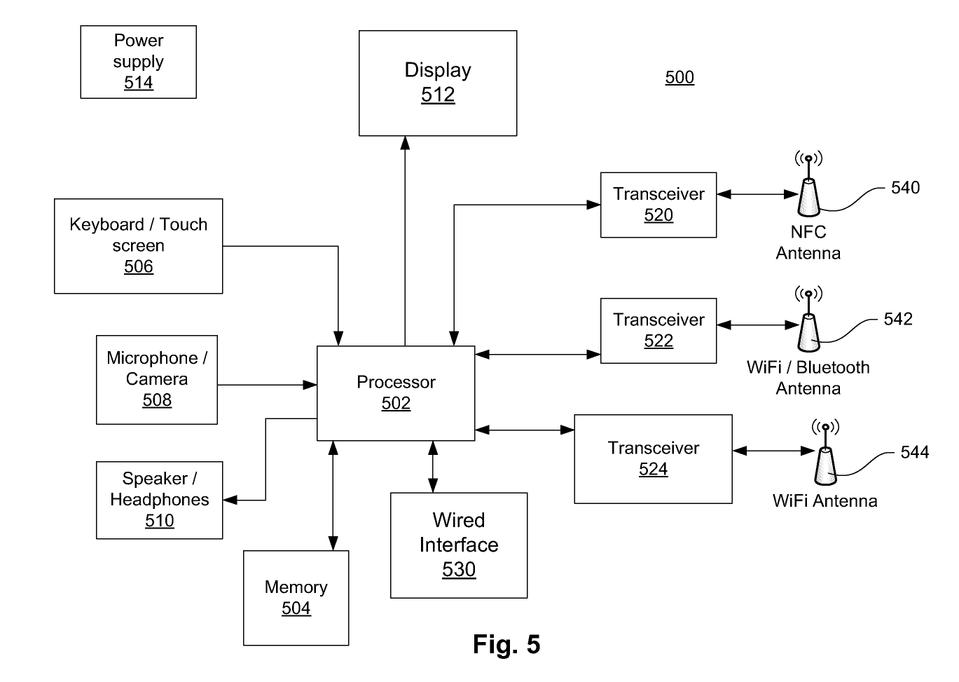

The components of an example mobile device 500 is further disclosed in FIG. 5 having a processor 502 executing instructions from volatile or non-volatile memory 504 and storing data thereto. The mobile device 500 has a number of human-computer interfaces such as a keypad or touch screen 506, a microphone and/or camera 508, a speaker or headphones 510, and a display 512, or any combinations thereof. The mobile device has a battery 514 supplying power to all the electronic components within the device. The battery 514 may be charged using wired or wireless charging.

The keyboard 506 could be a conventional keyboard found on most laptop computers or a soft-form keyboard constructed of flexible silicone material. The keyboard 506 could be a standard-sized 101-key or 104-key keyboard, a laptop-sized keyboard lacking a number pad, a handheld keyboard, a thumb-sized keyboard or a chorded keyboard known in the art. Alternatively, the mobile device 500 could have only a virtual keyboard displayed on the display 512 and uses a touch screen 506. The touch screen 506 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 506 could be a single touch or multi-touch screen. Alternatively, the microphone 508 may be used for input into the mobile device 500 using voice recognition.

The display 512 is typically small-size between the range of 1.5 inches to 14 inches to enable portability and has a resolution high enough to ensure readability of the display 512 at in-use distances. The display 512 could be a liquid crystal display (LCD) of any type, plasma, e-Ink®, projected, or any other display technology known in the art. If a touch screen 506 is present in the device, the display 512 is typically sized to be approximately the same size as the touch screen 506. The processor 502 generates a user interface for presentation on the display 512. The user controls the information displayed on the display 512 using either the touch screen or the keyboard 506 in conjunction with the user interface. Alternatively, the mobile device 500 may not have a display 512 and rely on sound through the speakers 510 or other display devices to present information.

The mobile device 500 has a number of network transceivers coupled to antennas for the processor to communicate with other devices. For example, the mobile device 500 may have a near-field communication (NFC) transceiver 520 and antenna 540; a WiFi®/Bluetooth® transceiver 522 and antenna 542; a cellular transceiver 524 and antenna 544 where at least one of the transceivers is a pairing transceiver used to pair devices. The mobile device 500 also may have a wired interface 530 such as USB or Ethernet connection.

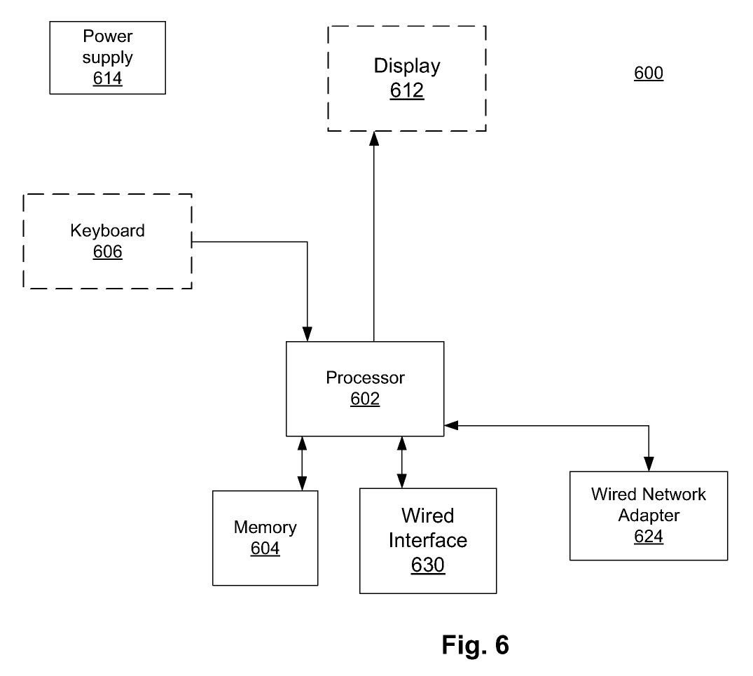

The servers 120, 122, 124 shown in FIG. 6 of the present embodiment have a similar structure to each other. The servers 120, 122, 124 have a processor 602 executing instructions from volatile or non-volatile memory 604 and storing data thereto. The servers 120, 122, 124 may or may not have a keyboard 306 and/or a display 312. The servers 120, 122, 124 communicate over the Internet 150 using the wired network adapter 624 to exchange information with the paired mobile device 105 and/or the capture board 108, conferencing, and sharing of captured content. The servers 120, 122, 124 may also have a wired interface 630 for connecting to backup storage devices or other type of peripheral known in the art. A wired power supply 614 supplies power to all of the electronic components of the servers 120, 122, 124.

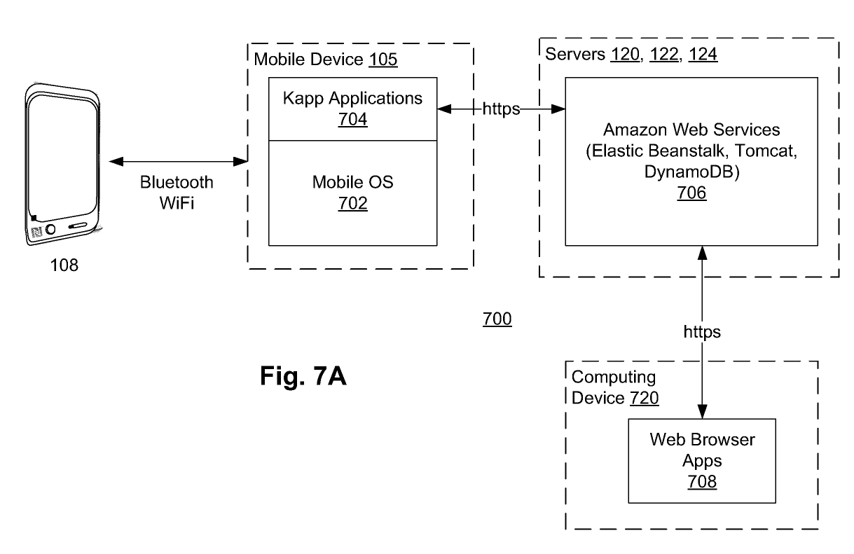

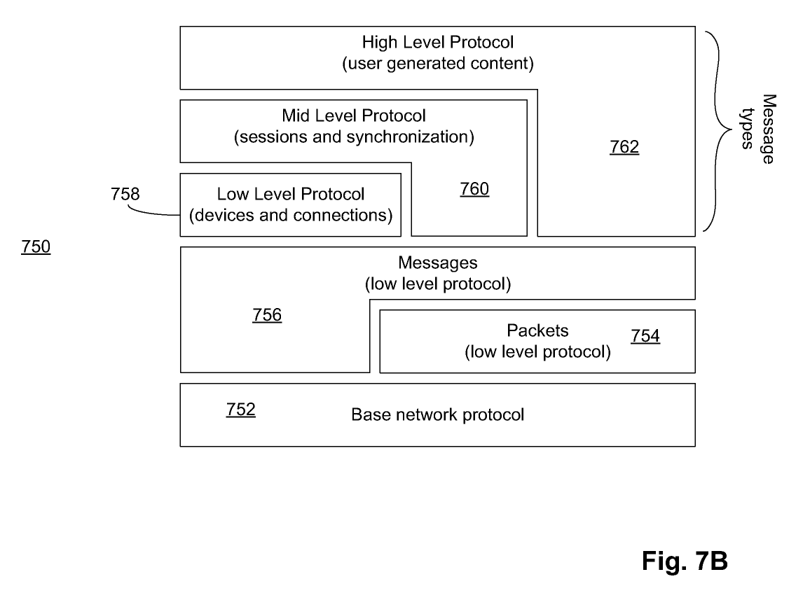

An overview of the system architecture 700 is presented in FIGS. 7A and 7B. The capture board 108 is paired with the mobile device 105 to create one or more wireless communications channels between the two devices. The mobile device 105 executes a mobile operating system (OS) 702 which generally manages the operation and hardware of the mobile device 105 and provides services for software applications 704 executing thereon. The software applications 704 communicate with the servers 120, 122, 124 executing a cloud-based execution and storage platform 706, such as for example Amazon Web Services, Elastic Beanstalk, Tomcat, DynamoDB, etc, using a secure hypertext transfer protocol (https). Any content stored on the cloud-based execution and storage platform 706 may be accessed using an HTML5-capable web browser application 708, such as Chrome, Internet Explorer, Firefox, etc, executing on a computer device 720. When the mobile device 105 connects to the capture board 108 and the servers 120, 122, 124, a session is generated as further described below. Each session has a unique session identifier.

FIG. 7B shows an example protocol stack 750 used by the devices connected to the session. The base network protocol layer 752 generally corresponds to the underlying communication protocol, such as for example, Bluetooth, WiFi Direct, WiFi, USB, Wireless USB, TCP/IP, UDP/IP, etc. and may vary based by the type of device. The packets layer 754 implement secure, in-order, reliable stream-oriented full-duplex communication when the base networking protocol 752 does not provide this functionality. The packets layer 754 may be optional depending on the underlying base network protocol layer 752. The messages layer 756 in particular handles all routing and communication of messages to the other devices in the session. The low level protocol layer 758 handles redirecting devices to other connections. The mid level protocol layer 760 handles the setup and synchronization of sessions. The High Level Protocol 762 handles messages relating the user generated content as further described herein. These layers are discussed in more detail below.

An application executing on the mobile device 500 and communicating with the capture board 108 may provide a user interface for controlling the properties of the transparent touch area 202. The user would change the settings on the mobile device (e.g. using a graphical user interface or touch gestures). Any change in the settings may be communicated with the capture board 108 using Bluetooth LE, WI-FI, etc.

Turning now to FIG. 8, the processing structure 302 defaults the privacy layer 478 and the diffusive layer 476 to be disabled in steps 804 and 806 by making the diffusive layer 476 transparent using diffusive and privacy layer control circuitry 318 and turning off the backlight 490 using backlight control circuitry 326. When the pointer 204 is detected by the touch system 404, or when ink is present on the touch area 202 (step 808), the ink on the board is stored within memory 306 as previously described and the processing structure 302 activates the diffusive layer 476 (step 812). The privacy layer 478 may be activated as well at this step dependent on the requirements. The processing structure 302 then reads the current light levels from one or more light sensors 483 and determines if a low light condition exists (step 814). If the light levels are deemed insufficient (either by referencing to a fixed threshold and/or a user-defined threshold), the processing structure 302 activates the backlight emitters 490 of the illumination layer 474 (step 816). If no ink or pointer is present on the board or if the light levels are sufficient, then the processing structure 302 determines if all ink has been erased from the touch area 202 (step 818). If all ink is erased, then the diffusive layer 476 and the illumination layers 474 are disabled (steps 804, 806), otherwise, the processing structure 302 continues to determine if all ink has been cleared (step 818).

In an alternative process (not shown), the processing structure 302 comprises a timer that counts down to zero. When the processing structure 302 detects the pointer 204 contacting the touch area 202, the processing structure 302 sets this timer to a user-specified or fixed value. If the timer reaches zero, the diffusive layer 476 is made transparent (step 804) and/or the backlight 490 is turned off (step 806). There may be a different timer for the privacy layer than the backlight. This enables touch area 202 to be transparent when the capture board 108 is not in use.

Although the embodiments above describe the capture board 108 having the touch area 202 smaller than the window 260, other embodiments may have the touch area 202 matching the size of the window 260 and the capture board 108 forms a frame around the entire window 260 or a partition of the window 260 as further described with reference to FIG. 10 below. The capture board 108 may form an environmental control system that may operate in conjunction with environmental sensors or other home control systems. In some embodiments, a user interface to control the transparent touch area 202 may be presented on the touch area 202 using a small touch-sensitive LCD, a pico projector, or other type of display technology.

Turning particularly to FIG. 10, environmental sensors may additionally provide input to the capture board 108 in order to control the diffusive layer 476 and/or illumination layer 474. The capture board 108 may further comprise a chromatic layer (not shown) that generally controls the color and/or reflectivity of the window 260. For example, a temperature sensor (e.g. thermocouple) (not shown) affixed to the window 260 may cause the window 260 to become more reflective in response to the window 260 increasing in temperature above a threshold level. In another example, a grid of microscopic photosensors 483 may be embedded in the film to sense the amount of light from the sun 1016 falling on the various areas of the window 260 and selectively apply PDLC or electro-chromic tinting in those areas/partitions 1010 and 1012 receiving the strongest or brightest sunlight. In yet another example, motion sensors or occupancy sensors 1014 on the interior side of the window 260 may detect the presence of occupants 1018 in the room and activate the diffusive layer 476 for enhanced privacy. In even yet another example, face/head detecting cameras 1014 may be mounted on the interior side of the window 260 in order to track faces/heads of the occupants 1018 and selectively apply chromatic filtering to a particular partition 1010, the filtering being different from the other partitions 1012, to prevent strong sunlight from shining in the eyes of the occupant 1018.

Additionally, the capture board 108 may be integrated with other home automatic and consumer electronic systems, such as an X10, Google Nest, or Apple HomeKit network, to further optimize performance, power consumption, and/or comfort according to a variety of heuristics or user customization. For example, the privacy layer 478 or electro-chromic tinting may be adjusted in conjunction with a plurality of lights 1002 to ensure a consistent amount of light in the room. When the light entering the window 260 is too high as detected by the light sensors 483, the tinting may be adjusted to decrease the amount of light. If the light in the room is too low as detected by the light sensors 483, the tinting may be adjusted to increase the amount of light entering the window 260. When the sun goes down, the intensity of the lights 1002 may be increased or the light injection into the illumination layer 474 may be increased. The lighting control system may also receive user input from the occupants 1018 from a light switch 1006 such as a dimmer. When the occupant 1018 dims the lights 1002 in the room, it may also dim the light entering via the window 260. The capture board 108 may adjust the amount of light based on the on-peak demand electrical prices. These customizations may additionally be controlled by a timer or thermostat 1008.

When used in conjunction with an application executing on the mobile device 105, profile data may be retrieved from a profile server 122 in order to customize the capture board 108. In some embodiments, the occupant 1018 may use the camera 508 to take images of the room as input into the environmental control system. For example, the occupant 1018 may stand in front of the window 260 in order to be detected by a proximity sensor 1014 located proximate to the window 260 and take a 360-degree panoramic image (or a smaller image, or a video clip) of the interior of the room. Through the use of a user interface on the mobile device 105, the user may then select objects within the image where light should not fall (e.g. dark zones), such as a valuable painting 1004 or a television set. Based on the travel of the sun 1016, the partitions 1010 and 1012 may be selectively shaded to keep the light off of the objects identified. The sun may be tracked using at least two of the light sensors 483 which may triangulate the position of the sun in the sky such as, for example, using a heliostat program. The light sensors 483 may be dispersed throughout the partitions. Based on the position of the sun and the angle to the object (e.g. valuable painting 1004), the capture board 108 may calculated which particular partitions require dark zones. In the instance of the television, the home entertainment system may communicate via the X10 or HomeKit that the occupant 1018 is watching a television program and ensure light does not fall on the television screen without needing to darken the entire room.

The number of partitions on a wall or window 260 generally corresponds to the size of the window 260. For example, larger windows 260 may have partition sizes of 1×1 feet (or larger) whereas smaller windows 260 may have partitions sizes of 0.5×0.5 feet. Alternatively, the entire window 260 may be a single partition in order to lessen cost of the window 260. The partition sizes may be square, rectangular (oriented vertically or horizontally), or any other two dimensional shape corresponding to the window shape 260. Although the window or wall 260 is described herein as a vertical surface, other embodiments may have the window or wall 260 oriented at a different angle (such as in a skylight).

Although the embodiments herein describe a capture board 108 mounted to a window 260, in other applications, the concepts and examples described herein may be used with transparent LED/OLED displays. For example, the concepts and examples may apply equally well to digital signage or other transparent interactive touch screen.

In some embodiments, the capture board 108 electronics may learn the behavior of the occupant 1018. For example, the capture board 108 may learn when the occupant 1018 wakes up in the morning and adjust the privacy layer 478 to allow a high degree of light while still preserving privacy as the occupant 1018 is not yet dressed. As the occupant 1018 interacts with the manual controls, the capture board 108 notes the time of day, day of the week, and the readings from the environmental sensors to build a profile of occupant preferences. For example, one family that has weekday suppers at 6 pm wants a high level of light in the kitchen while they eat and at 7 pm, the family retires to a different room of the house to watch television, where they want less light. On the weekends, the family lingers in the kitchen longer, preferring to play games together after supper. The capture board 108 may learn from such regularly observed patterns of occupant behavior to eventually be able to apply the right amount of filtration without the need for occupants to invoke manual controls.

The capture board 108 may additionally receive non-profile data from third party data providers via the WiFi antenna 344 and transceiver 324 from a global network such as the Internet or “cloud”. For example, the capture board 108 may check weather conditions from one or more weather providers and adjust the filtering if skies are overcast or sunny. The capture board 108 may adjust the light by deactivating light blocking films and activating a blue filter film along the top of the window 260 to create the experience of blue skies. The capture board 108 may receive traffic data from computerized traffic systems and adjust the filtering of the window 260.

Although the embodiments herein describe the privacy, window, and diffusive layers as discrete layers, these layers may be combined into a single layer, or the layers may be sufficiently thin to appear as a window without layers. The layers may be a film that may be applied to a conventional window.

Although the embodiments herein describe a specific type of privacy layer and diffusive layer, other technologies may be used. For example, one technique comprises pointing a projector to a piece of glass with a diffusing material on top. In another alternative, it is possible to place a Liquid Crystal Display (LCD) on top of the glass. In this alternative, the LCD is opaque when the colour displayed is black and most transparent when the colour displayed is white, which provides about 10% transmittance therethrough. LG manufactures an LCD with a fourth blank pixel (where the other pixels are the standard Red-Green-Blue RGB variety) that allows 15% transmittance. The result is a dark image unless there is a bright source of light behind the display.

Yet another example of a diffusive layer is a polymer dispersed liquid crystal (PDLC) that is opaque until an electrical current is applied. The PDLC may be used as a blind to diffuse light passing therethrough. One example is Invisishade, produced by InvisiShade, LLC of Greenville, S.C., U.S.A., that has a transmittance of 78% when clear and 7% when frosted.

In yet another alterative, the illumination layer 474 may comprise ultraviolet or infrared responsive particles and the processing structure 302 may activate a UV or infrared illuminator to cause illumination of the light passing therethrough.

Although the embodiments described herein refer to a capture board 108 affixed to the interior of a window, the emitters and detectors may be embedded within or behind the window anchors or alternatively between the seals between the windows providing a seamless interactive area. Alternatively, the emitters and detectors may be embedded in or affixed to an opaque wall or other architectural surface.

In some embodiments, the touch areas 202 may comprise an array of windows 260, each with a unique identifier readable by the mobile device 105, such as a barcode, Quick Response (QR) code, Near Field Communication (NFC), etc., enabling a user to interact with any available window 260 and have the content stored within their particular mobile device 105.

Although the embodiments herein describe a single panel for a window, other embodiments may partition the window into a plurality of partitions with multiple films and associated electrical control circuits so that each partition of the window may be filtered in different manner such as different transmissivity, reflectivity, etc. or combination thereof. For example, the diffusive layer 476 may be partitioned into a grid of rectangular partitions with each partition being independently controlled by selectively turning individual partitions on, off, or changing the light properties.

Although the embodiments described herein refer to a pen, the pointer 204 may be any type of pointing device such as a dry erase marker, ballpoint pen, ruler, pencil, finger, thumb, or any other generally elongate member. Preferably, these pen-type devices have one or more ends configured of a material as to not damage the touch area 202 when coming into contact therewith under in-use forces.

The emitters and detectors may be narrower or wider, narrower angle or wider angle, various wavelengths, various powers, coherent or not, etc. As another example, different types of multiplexing may be used to allow light from multiple emitters to be received by each detector. In another alternative, the FPGA 302 may modulate the light emitted by the emitters to enable multiple emitters to be active at once.

The touch screen 506 may be any type of transparent touch technology such as analog resistive, capacitive, projected capacitive, ultrasonic, infrared grid, camera-based (across touch surface, at the touch surface, away from the display, etc), in-cell optical, in-cell capacitive, in-cell resistive, time-of-flight, frustrated total internal reflection (FTIR), diffused surface illumination, surface acoustic wave, bending wave touch, acoustic pulse recognition, force-sensing touch technology, or any other touch technology known in the art. The touch screen 506 could be a single touch, a multi-touch screen, or a multi-user, multi-touch screen.

Although the mobile device 200 is described as a smartphone 102, tablet 104, or laptop 106, in alternative embodiments, the mobile device 105 may be built into a conventional pen, a card-like device similar to an RFID card, a camera, or other portable device.

Although the servers 120, 122, 124 are described herein as discrete servers, other combinations may be possible. For example, the three servers may be incorporated into a single server, or there may be a plurality of each type of server in order to balance the server load.

These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the entire disclosures of which are incorporated by reference; touch systems comprising touch panels or tables employing electromagnetic, capacitive, acoustic or other technologies to register pointer input; laptop and tablet personal computers (PCs); smartphones, personal digital assistants (PDAs) and other handheld devices; and other similar devices.

Although the embodiments described herein pair using NFC or QR code, the inventor contemplates that other means of communication may be used for pairing and general communication between the devices, such as, but not limited to, WiFi, Bluetooth, WiFi Direct, LTE, 3G, wired Ethernet, Infrared, 1-dimensional bar code, etc.

Although the examples described herein are in reference to a capture board 108, the inventor contemplates that the features and concepts may apply equally well to other collaborative devices 107 such as the interactive flat screen display 110, interactive whiteboard 112, the interactive table 114, or other type of interactive device. Each type of collaborative device 107 may have the same protocol level or different protocol levels.

The above-described embodiments are intended to be examples of the present invention and alterations and modifications may be effected thereto, by those of skill in the art, without departing from the scope of the invention, which is defined solely by the claims appended hereto.

What is claimed is:

1. An interactive device comprising:
a processing structure;
a light transmissive medium having an interior side and an exterior side;
the interior side comprising an interactive surface;
a layer on the exterior side, the layer transforming between a transparent state and a non-transparent state;
a tangible computer-readable memory in communication with the processing structure, the memory comprising instructions to configure the processing structure to:
detect a pointer contacting the interactive surface;
compute the location of the pointer relative to the medium to determine annotations drawn on the interactive surface using the pointer; and
transform the layer from the transparent to the non-transparent state.

2. (canceled)

3. The interactive device according to claim 1, wherein the interactive surface is surrounded by a frame on the interior side, and the interactive surface comprises at least one emitter and the at least one detector coupled to the frame.

4. (canceled)

5. The interactive device according to claim 3, wherein the interactive surface comprises capacitive sensors coated on a substrate.

6. The interactive device according to claim 1, wherein the interactive device further comprises an illumination layer on the exterior side; an illuminator configured to emit light into the illumination layer; and a light sensor measuring ambient light on the exterior side.

7. The interactive device according to claim 6, wherein the illuminator emits ultraviolet light; and the pointer deposits fluorescent ink on the interior side.

8. (canceled)

9. The interactive device according to claim 6, wherein the computer-readable memory further comprises instructions to configure the processing structure to receive a measurement of ambient light on the exterior side.

10. The interactive device according to claim 9, wherein the computer-readable memory further comprises instructions to configure the processing structure to activate the illuminator if the measurement of ambient light levels is below a threshold.

11. The interactive device according to claim 9, wherein the computer-readable memory further comprises instructions to configure the processing structure to activate the illuminator in proportion to the measurement of the ambient light.

12. The interactive device according to claim 1, further comprising a privacy layer on the exterior side, the privacy layer transitioning between a clear state and an opaque state.

13. The interactive device according to claim 12, wherein the privacy layer comprises an electro-chromic film that becomes tinted in response to an electric potential applied thereto.

14. The interactive device according to claim 12, wherein the privacy layer becomes tinted when an occupancy sensor detects at least one person in proximity to the light transmissive medium.

15-16. (canceled)

17. The interactive device according to claim 1, wherein the computer-readable memory further comprises instructions to configure the processing structure to generate a privacy timer whereby the privacy timer determines when the signal to the layer is disabled.

18. The interactive device according to claim 9, wherein the computer-readable memory further comprises instructions to configure the processing structure to generate an illuminator timer whereby the illuminator timer determines when the illuminator is deactivated.

19. An touch system kit comprising:
a plurality of emitters affixed to an interior frame of a window and emitting light to illuminate at least a portion of the window;
a plurality of optical sensors affixed to the interior frame of the window receiving the light;
a transceiver;
a processing structure in communication with the emitters and the optical sensors; the processing structure further in communication with the transceiver;
a film for application to the window, the film electrically coupled to with the processing structure;
a tangible computer-readable medium in communication with the processing structure comprising instructions to:
emit light from the emitters according to a pattern;
receive signals from the optical sensors;
interpreting the signals in order to detect a pointer contacting the window;
transmitting the pointer contacts over the transceiver to a remote processing structure; and
signaling the film to transform between a transparent state and a non-transparent state.

20. (canceled)

21. The touch system kit according to claim 19, further comprising:
the film comprising at least one of a diffusive layer, an illumination layer, or a combination of the diffusive layer and the illumination layer;
when the film comprises the illumination layer, the touch system kit further comprises an illuminator configured to emit light into the illumination layer; and at least one light sensor for detecting ambient light levels.

22. The touch system kit according to claim 21, when the film comprises the diffusive layer, further comprising instructions to configure the processing structure to:
apply a signal to the diffusive layer to transform the diffusive layer into a non-transparent state.

23. The touch system kit according to claim 21 further comprising instructions to configure the processing structure to:
determine ambient light levels and if the ambient light levels are below a threshold, activate the illuminator.

24. A method of applying an interactive device to a window comprising:
applying a frame to an interior surface of the window; the frame having a plurality of emitters and receivers formed therein;
applying a film to either the interior surface or an exterior surface of the window;
emitting a signal from the emitters according to a pattern;
receiving the signals from the receivers at a processing structure;
processing the signals to detect and locate a pointer contacting the window;
transmitting the pointer location to a remote processing structure over a transceiver; and
signaling the film to transform from a transparent state to a non-transparent state.

25. The method of claim 24 further comprising: transforming the film to become non-transparent on detection of the pointer.

26. The method of claim 24 further comprising: pairing the transceiver with a remote transceiver using a unique identifier on the window.
